(19) United States
(12) Patent Application Publication
(10) Pub. No.: US 2021/0289693 A1
(43) Pub. Date: Sep. 23, 2021

(54) SYSTEM AND METHOD FOR MONITORING THE OPERATION OF AN AGRICULTURAL SPRAYER USING DROPLET SIZE AND/OR SHAPE

(71) Applicant: CNH Industrial America LLC, New Holland, PA (US)

(72) Inventors: Andrew W. Harmon, Sheboygan, WI (US); Trevor Stanhope, Palos Hills, IL (US)

(21) Appl. No.: 16/826,798

(22) Filed: Mar. 23, 2020

(51) Int. Cl. A01C 23/00; B05B 12/08; B05B 1/20; A01M 7/00; A01C 23/04; A01C 21/00

(52) U.S. Cl. CPC A01C 23/007; B05B 12/082; B05B 1/20; A01C 21/00; A01M 7/0089; A01C 23/047; A01M 7/0042

(57) ABSTRACT

A system for monitoring an operation of an agricultural sprayer includes a boom and a nozzle mounted on the boom. The nozzle is, in turn, configured to dispense an agricultural fluid onto an underlying plant as the agricultural sprayer travels across a field. Furthermore, the system includes an imaging device configured to capture image data depicting a droplet of the agricultural fluid that has been deposited onto the underlying plant. Additionally, the system includes a computing system communicatively coupled to the imaging device. As such, the computing system is configured to receive the captured image data from the imaging device. Moreover, the computing system is further configured to analyze the received image data to determine at least one of a size or a shape of the droplet.

### FIELD OF THE INVENTION

The present disclosure generally relates to agricultural sprayers and, more particularly, to a system and method for monitoring the operation of an agricultural sprayer using the size and/or shape of the droplets of agricultural fluid dispensed by the sprayer.

### BACKGROUND OF THE INVENTION

Agricultural sprayers apply an agricultural fluid (e.g., a pesticide) onto crops as the sprayer is traveling across a field. In general, the agricultural fluid is applied at a target application rate to achieve a desired agricultural outcome (e.g., a reduction in weed coverage or pest activity). As such, a typical sprayer includes a boom assembly on which a plurality of spaced apart nozzles is mounted. Each nozzle is, in turn, configured to dispense or otherwise spray the agricultural fluid onto underlying crops and/or weeds at the target application rate and/or with a desired spray quality (e.g., droplet size, shape, and the like). In this respect, systems have been developed to monitor the operation of the sprayer to ensure that target application rate and/or the desired spray quality is met as field conditions vary. However, further improvements are needed.

Accordingly, an improved system and method for monitoring the operation of an agricultural sprayer would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to a system for monitoring an operation of an agricultural sprayer. The system includes a boom and a nozzle mounted on the boom, with the nozzle configured to dispense an agricultural fluid onto an underlying plant as the agricultural sprayer travels across a field. Furthermore, the system includes an imaging device configured to capture image data depicting a droplet of the agricultural fluid that has been deposited onto the underlying plant. Additionally, the system includes a computing system communicatively coupled to the imaging device. As such, the computing system is configured to receive the captured image data from the imaging device. Moreover, the computing system is further configured to analyze the received image data to determine at least one of a size or a shape of the droplet.

In another aspect, the present subject matter is directed to a method for monitoring an operation of an agricultural sprayer. The agricultural sprayer, in turn, includes a boom and a nozzle mounted on the boom, with the nozzle configured to dispense an agricultural fluid onto an underlying plant as the agricultural sprayer travels across a field. As such, the method includes controlling, with a computing system, an operation of the agricultural sprayer such that the agricultural sprayer performs a spraying operation relative to the field as the agricultural sprayer travels across the field. Additionally, the method includes receiving, with the computing system, image data depicting a droplet of the agricultural fluid that has been deposited onto the underlying plant. Furthermore, the method includes analyzing, with the computing system, the received image data to determine at least one of a size or a shape of the droplet. Moreover, the method includes comparing, with the computing system, the determined at least one of the size or the shape to a predetermined range. In addition, the method includes initiating, with the computing system, a control action when the determined at least one of the size or the shape falls outside of the predetermined range.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of one embodiment of an agricultural sprayer in accordance with aspects of the present subject matter;

FIG. 2 illustrates a side view of the agricultural sprayer shown in FIG. 1, particularly illustrating various components thereof;

FIG. 3 illustrates a partial front view of one embodiment of a boom assembly of an agricultural sprayer in accordance with aspects of the present subject matter, particularly illustrating various fluid components coupled to the boom assembly;

FIG. 4 illustrates a schematic view of one embodiment of a system for monitoring an operation of an agricultural sprayer in accordance with aspects of the present subject matter; and

FIG. 5 illustrates a flow diagram of one embodiment of a method for monitoring an operation of an agricultural sprayer in accordance with aspects of the present subject matter.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to systems and methods for monitoring the operation of an agricultural sprayer. Specifically, in several embodiments, the sprayer may include a boom assembly and one or more nozzles mounted on the boom assembly. Each nozzle may, in turn, be configured to dispense an agricultural fluid (e.g., a pesticide or a nutrient) onto one or more underlying plants as the agricultural sprayer travels across a field to perform a spraying operation. In this respect, a computing system may be configured to receive image data depicting one or more droplets that have been deposited on the underlying plant(s). Thereafter, the computing system may be configured to analyze received image data to determine one or more values associated with the size and/or the shape of the imaged droplet(s). Additionally, in some embodiments, the dispensed agricultural fluid may contain a dye (e.g., an ultraviolet dye) to improve the accuracy of droplet size/shape determination(s).

Furthermore, in several embodiments, the computing system may be configured to initiate one or more control actions when the determined droplet size/shape value(s) falls outside of an associated predetermined range. Specifically, in several embodiments, the computing system may be configured to compare the determined droplet size/shape value(s) to the associated predetermined range. When the determined droplet size/shape value(s) falls outside of the associated predetermined range, the computing system may be configured to initiate an adjustment to the height of the boom assembly relative to a canopy of the underlying plant, the pressure of the agricultural fluid supplied to the nozzle(s), and/or the ground speed of the sprayer.

Monitoring the operation of the agricultural sprayer using the determined droplet size/shape value(s) may ensure that the target application rate of the agricultural substance and/or the desired spray quality is maintained as field conditions change. More specifically, parameters associated with the spray fan(s) (e.g., the size and/or shape of the spray fan(s)) of the agricultural fluid dispensed by the nozzle(s) are indirect indicators of application rate and spray quality. However, the droplet size/shape value(s) are direct indicators of application rate and spray quality. In this respect, monitoring the operation of the agricultural sprayer using the determined droplet size/shape value(s) may improve agricultural outcomes.

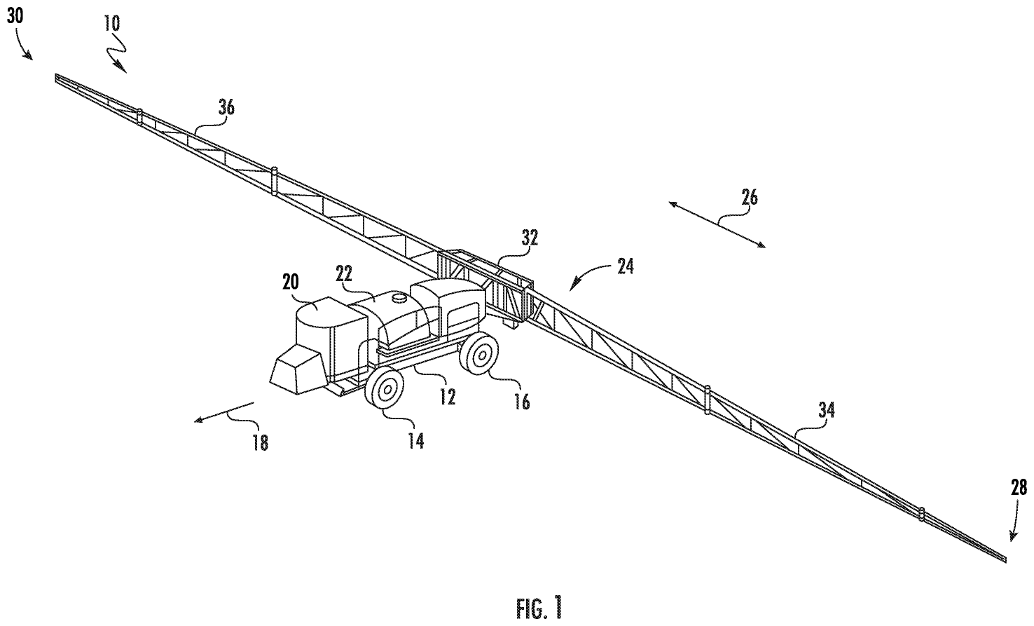

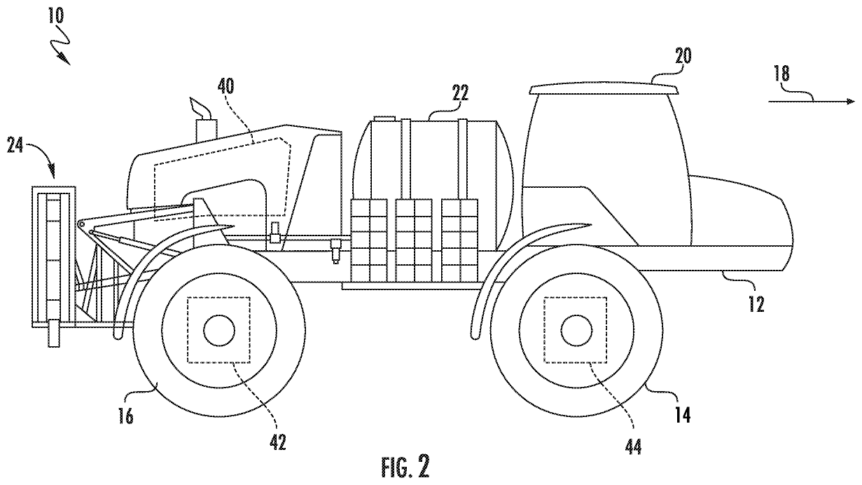

Referring now to the drawings, FIGS. 1 and 2 illustrate differing views of one embodiment of an agricultural sprayer 10 in accordance with aspects of the present subject matter. Specifically, FIG. 1 illustrates a perspective view of the agricultural sprayer 10. Additionally, FIG. 2 illustrates a side view of the agricultural sprayer 10, particularly illustrating various components of the agricultural sprayer 10.

In the illustrated embodiment, the agricultural sprayer 10 is configured as a self-propelled agricultural sprayer. However, in alternative embodiments, the agricultural sprayer 10 may be configured as any other suitable agricultural vehicle that dispenses an agricultural fluid (e.g., a pesticide or a nutrient) while traveling across a field, such as an agricultural tractor and an associated implement (e.g., a towable sprayer, an inter-seeder, a side-dresser, and/or the like).

As shown in FIGS. 1 and 2, the agricultural sprayer 10 includes a frame or chassis 12 configured to support or couple to a plurality of components. For example, a pair of steerable front wheels 14 and a pair of driven rear wheels 16 may be coupled to the frame 12. The wheels 14, 16 may be configured to support the agricultural sprayer 10 relative to the ground and move the sprayer 10 in the direction of travel 18 across the field. Furthermore, the frame 12 may support an operator's cab 20 and a tank 22 configured to store or hold an agricultural fluid, such as a pesticide (e.g., a herbicide, an insecticide, a rodenticide, and/or the like), a fertilizer, or a nutrient. However, in alternative embodiments, the sprayer 10 may include any other suitable configuration. For example, in one embodiment, the front wheels 14 of the sprayer 10 may be driven in addition to or in lieu of the rear wheels 16.

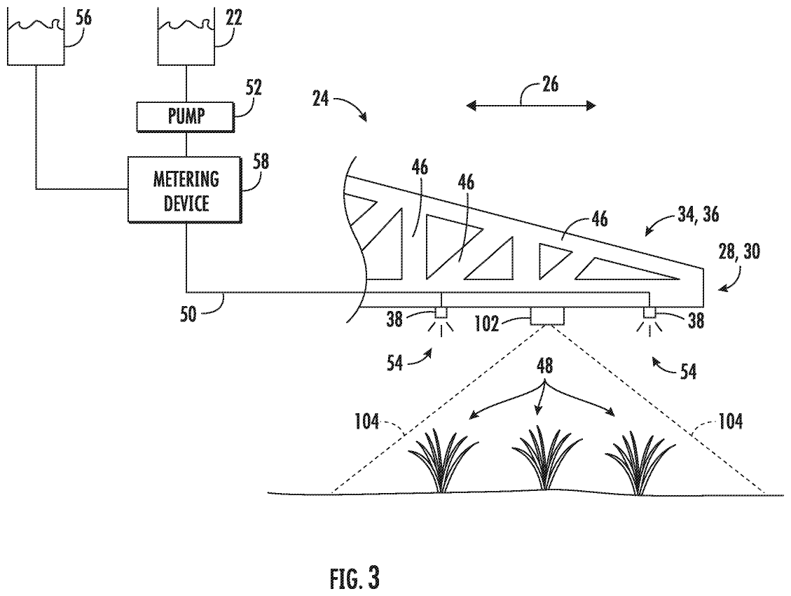

Additionally, the sprayer 10 may include a boom assembly 24 mounted on the frame 12. In general, the boom assembly 24 may extend in a lateral direction 26 between a first lateral end 28 and a second lateral end 30. In one embodiment, the boom assembly 24 may include a center section 32 and a pair of wing sections 34, 36. As shown in FIG. 1, a first wing section 34 extends outwardly in the lateral direction 26 from the center section 32 to the first lateral end 28. Similarly, a second wing section 36 extends outwardly in the lateral direction 26 from the center section 32 to the second lateral end 30. As will be described below, a plurality of nozzles 38 (FIG. 3) may be mounted on the boom assembly 24 and configured to dispense the agricultural fluid stored in the tank 22 onto the underlying plants. However, in alternative embodiments, the boom assembly 24 may include any other suitable configuration.

Referring particularly to FIG. 2, the agricultural sprayer 10 may include one or more devices or components for adjusting the speed at which the sprayer 10 moves across the field in the direction of travel 18. Specifically, in several embodiments, the agricultural sprayer 10 may include an engine 40 and a transmission 42 mounted on the frame 12. In general, the engine 40 may be configured to generate power by combusting or otherwise burning a mixture of air and fuel. The transmission 42 may, in turn, be operably coupled to the engine 40 and may provide variably adjusted gear ratios for transferring the power generated by the engine power to the driven wheels 16. For example, increasing the power output by the engine 40 (e.g., by increasing the fuel flow to the engine 40) and/or shifting the transmission 42 into a higher gear may increase the speed at which the agricultural sprayer 10 moves across the field. Conversely, decreasing the power output by the engine 40 (e.g., by decreasing the fuel flow to the engine 40) and/or shifting the transmission 42 into a lower gear may decrease the speed at which the agricultural sprayer 10 moves across the field.

Additionally, the agricultural sprayer 10 may include one or more braking actuators 44 that, when activated, reduce the speed at which the agricultural sprayer 10 moves across the field, such as by converting energy associated with the movement of the sprayer 10 into heat. For example, in one embodiment, the braking actuator(s) 44 may correspond to a suitable hydraulic cylinder(s) configured to push a stationary frictional element(s) (not shown), such as a brake shoe(s) or a brake caliper(s), against a rotating element(s) (not shown), such as a brake drum(s) or a brake disc(s). However, in alternative embodiments, the braking actuator(s) 44 may any other suitable hydraulic, pneumatic, mechanical, and/or electrical component(s) configured to convert the rotation of the rotating element(s) into heat. Furthermore, although FIG. 2 illustrates one braking actuator 44 provided in operative association with each of the steerable wheels 14, the agricultural sprayer 10 may include any other suitable number of braking actuators 44. For example, in one embodiment, the agricultural sprayer 10 may include one braking actuator 44 provided in operative association with each of the driven wheels 16 in addition to or in lieu of the steerable wheels 14.

Referring now to FIG. 3, a partial front view of one embodiment of a boom assembly 24 is illustrated in accordance with aspects of the present subject matter. In general, the boom assembly 24 may include a plurality of structural frame members 46, such as beams, bars, and/or the like. Moreover, as mentioned above, the boom assembly 24 may support a plurality of nozzles 38 (also referred to as spray tips). Each nozzle 38 may, in turn, be configured to dispense the agricultural fluid stored within the tank 22 onto underlying plants 48. Specifically, as shown, the nozzles 38 are mounted on and/or coupled to the frame members 46 such that the nozzles 38 are spaced apart from each other in the lateral direction 26. Furthermore, fluid conduit(s) 50 may fluidly couple the nozzles 38 to the tank 22. Moreover, a pump 52 may be configured to receive agricultural fluid from the tank 22 and supply a pressurized flow of the agricultural fluid to the nozzles 38. In this respect, as the sprayer 10 travels across the field in the direction of travel 18 to perform a spraying operation thereon, each nozzle 38 may dispense or otherwise spray a fan 54 of the agricultural fluid. The dispensed agricultural fluid may, in turn, be deposited onto the underlying plants 48 (e.g., the underlying crops and/or weeds) in the form droplets.

In several embodiments, the agricultural fluid dispensed by the nozzles 38 may include a dye. Specifically, in some embodiments, the sprayer 10 may include a dye tank 56 configured to store a dye and a metering device 58 configured to dispense the dye into the flow of the agricultural fluid to the nozzles 38. For example, in the illustrated embodiments, the metering device 58 may be fluidly coupled to the conduit(s) 50. As such, the metering device 58 may be configured to control the rate at which the dye is dispensed from the dye tank 56 into the flow of the agricultural fluid. In this respect, the metering device 58 may correspond to any suitable electronically or mechanically controlled metering valve, such as needle valve. Alternatively, the dye may be manually added to the agricultural fluid in the tank 22 by the operator.

The dye dispensed into the agricultural fluid may correspond to any suitable substance that emits a light detectable by a suitable image device. For example, the dye may be an ultraviolet or fluorescent dye, an infrared dye (e.g., an azide dye), or a visible dye.

It should be further appreciated that the configuration of the sprayer 10 described above and shown in FIGS. 1-3 is provided only to place the present subject matter in an exemplary field of use. Thus, it should be appreciated that the present subject matter may be readily adaptable to any manner of vehicle configuration.

In accordance with aspects of the present subject matter, one or more imaging devices 102 may be installed on the sprayer 10. In general, the imaging device(s) 102 may be configured to capture image data depicting the droplets of the agricultural fluid that have been deposited on the underlying plants 48 by the nozzles 38 as the sprayer 10 travels across the field. As will be described below, a computing system may be configured to analyze the captured image data to determine the size and/or shape of the imaged droplets for use in monitoring the operation of the sprayer 10.

In general, the imaging device(s) 102 may correspond to any suitable sensing device(s) configured to detect or capture images or other image-like data depicting the droplets of the agricultural fluid deposited on the plants within the field. For example, as mentioned above, in several embodiments, the agricultural fluid may contain an ultraviolet dye. In one such embodiment, the imaging device(s) 102 may correspond to a suitable ultraviolet camera(s) configured to capture ultraviolet images of the plants 48 and the agricultural fluid droplets deposited thereon within its field of view (indicated by dashed lines 104). As such, the ultraviolet camera(s) may capture the ultraviolet light emitted by the ultraviolet dye present within the deposited droplets, thereby facilitating identification and analysis (e.g., size and/or shape determinations) of the droplets. Alternatively, in another such embodiment, the imaging device(s) 102 may correspond to an RGB camera(s) and an associated ultraviolet light source configured to illuminate the plants 48 and the agricultural fluid droplets deposited thereon within its field of view 104. However, in alternative embodiments, the imaging device(s) 102 may correspond to any other suitable sensing device(s) configured to capture image or image-like data, such as an infrared camera(s) (e.g., when an infrared dye is used) or a RGB camera(s) (e.g., when a visible dye or no dye is used).

The imaging device(s) 102 may be installed at any suitable location(s) that allow the imaging device(s) 102 to capture image data depicting the droplets of the agricultural fluid deposited on the plants 48. For example, in the one embodiment, an imaging device 102 be mounted on each wing section 34, 36 of the boom assembly 24. As such, each imaging device 102 has an field of view 104 directed at the plants 48 positioned underneath the corresponding boom section 34, 36. In such an embodiment, the imaging devices 102 may capture images or other image data depicting the agricultural fluid droplets deposited on the plants 48 positioned under the wing sections 34, 36. However, in alternative embodiments, the imaging device(s) 102 may be installed at any other suitable location(s), such as on the roof of the cab 20. Additionally, any other suitable number of imaging devices 102 may be installed on the sprayer 10.

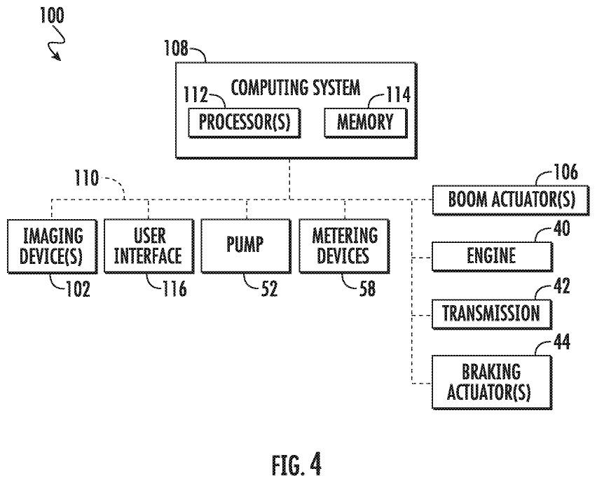

Referring now to FIG. 4, a schematic view of one embodiment of a system 100 for monitoring the operation of an agricultural sprayer is illustrated in accordance with aspects of the present subject matter. In general, the system 100 will be described herein with reference to the agricultural sprayer 10 described above with reference to FIGS. 1-3. However, it should be appreciated by those of ordinary skill in the art that the disclosed system 100 may generally be utilized with agricultural sprayers having any other suitable sprayer configuration.

As shown in FIG. 4, the system 100 may include one or more boom assembly actuator(s) 106 of the sprayer 10. In general, the boom assembly actuator(s) 106 may be configured to raise and lower the boom assembly 24 relative to the canopy of the underlying plants. For example, in one embodiment, the boom assembly actuator(s) 106 may correspond to one or more hydraulic cylinders configured to raise and lower the boom assembly 24 relative to the sprayer frame 12. However, in alternative embodiments, the boom assembly actuator(s) 106 may correspond to any other suitable actuating device(s), such as an electric linear actuator(s).

In accordance with aspects of the present subject matter, the system 100 may include a computing system 108 communicatively coupled to one or more components of the agricultural sprayer 10 to allow the operation of such components to be electronically or automatically controlled by the computing system 140. For instance, the computing system 140 may be communicatively coupled to the engine 40, the transmission 42, and/or the braking actuator(s) 44 (e.g., via the communicative link 110). As such, the computing system 140 may be configured to initiate adjustment of the ground speed at which the sprayer 10 travels across the field by controlling the operation of such components 40, 42, 44. Moreover, the computing system 140 may be communicatively coupled to the boom assembly actuator(s) 106 (e.g., via the communicative link 110). In this respect, the computing system 140 may be configured to initiate adjustment of the vertical distance between the boom assembly 24 and the canopy of the underlying plants by controlling the operation of the actuator(s) 106. Furthermore, the computing system 140 may be communicatively coupled to the pump 52 (e.g., via the communicative link 110). Thus, the computing system 140 may be configured to initiate adjustment of the pressure of the agricultural fluid supplied to the nozzles 38 by controlling the operation of pump 52. Additionally, the computing system 140 may be communicatively coupled to the metering device 58 (e.g., via the communicative link 110). As such, the computing system 140 may be configured to initiate adjustment the amount or concentration of the dye within the agricultural fluid by controlling the operation of such components 40, 42, 44. In addition, the computing system 140 may be communicatively coupled to the imaging device(s) 102 and/or any other suitable components of the sprayer 10 (e.g., via the communicative link 110).

In general, the computing system 108 may comprise one or more processor-based devices, such as a given controller or computing device or any suitable combination of controllers or computing devices. Thus, in several embodiments, the computing system 108 may include one or more processor(s) 112 and associated memory device(s) 114 configured to perform a variety of computer-implemented functions. As used herein, the term “processor” refers not only to integrated circuits referred to in the art as being included in a computer, but also refers to a controller, a microcontroller, a microcomputer, a programmable logic circuit (PLC), an application specific integrated circuit, and other programmable circuits. Additionally, the memory device(s) 114 of the computing system 108 may generally comprise memory element(s) including, but not limited to, a computer readable medium (e.g., random access memory RAM)), a computer readable non-volatile medium (e.g., a flash memory), a floppy disk, a compact disk-read only memory (CD-ROM), a magneto-optical disk (MOD), a digital versatile disk (DVD) and/or other suitable memory elements. Such memory device(s) 114 may generally be configured to store suitable computer-readable instructions that, when implemented by the processor(s) 112, configure the computing system 108 to perform various computer-implemented functions, such as one or more aspects of the methods and algorithms that will be described herein. In addition, the computing system 108 may also include various other suitable components, such as a communications circuit or module, one or more input/output channels, a data/control bus and/or the like.

The various functions of the computing system 108 may be performed by a single processor-based device or may be distributed across any number of processor-based devices, in which instance such devices may be considered to form part of the computing system 108. For instance, the functions of the computing system 108 may be distributed across multiple application-specific controllers, such as a pump controller, an engine controller, a transmission controller, and/or the like.

Furthermore, in one embodiment, the system 100 may also include a user interface 116. More specifically, the user interface 116 may be configured to provide feedback (e.g., feedback associated with the size and/or shape of the agricultural fluid droplets deposited on the plants within the field) to the operator of the sprayer 10. As such, the user interface 116 may include one or more feedback devices (not shown), such as display screens, speakers, warning lights, and/or the like, which are configured to provide feedback from the computing system 108 to the operator. The user interface 116 may, in turn, be communicatively coupled to the computing system 108 via the communicative link 110 to permit the feedback to be transmitted from the computing system 108 to the user interface 116. In addition, some embodiments of the user interface 116 may include one or more input devices (not shown), such as touchscreens, keypads, touchpads, knobs, buttons, sliders, switches, mice, microphones, and/or the like, which are configured to receive user inputs from the operator. In one embodiment, the user interface 116 may be mounted or otherwise positioned within the cab 20 of the sprayer 10. However, in alternative embodiments, the user interface 116 may mounted at any other suitable location.

In several embodiments, the computing system 108 may be configured to control the operation of the agricultural sprayer 10 such that the sprayer 10 is moved across a field to perform a spraying operation. In general, during the spraying operation, one or more nozzles 38 mounted on the boom assembly 24 may be configured to dispense a spray fan of the agricultural fluid stored within the tank 22 on the underlying plants (e.g., crops and/or weeds). The dispensed agricultural fluid may, in turn, be deposited on the underlying plants in form of droplets. For example, the computing system 108 may be configured to control operation of one more components of the sprayer 10 (e.g., the engine 40, the transmission 42, the braking actuator(s) 44, the pump 52, and/or the metering device 58) such that sprayer 10 dispenses one or more spray fans of the agricultural fluid as the sprayer 10 travels across the field in the direction of travel 18.

Additionally, the computing system 108 may be configured to determine the sizes and/or shapes of the agricultural fluid droplets deposited on the plants during the spraying operation. More specifically, as described above, one or more imaging devices 102 may be supported or installed on the sprayer 10 such that the imaging device(s) 102 captures image data depicting the agricultural fluid droplets deposited on the underlying plants. In this respect, as the sprayer 10 travels across the field to perform the spraying operation thereon, the computing system 108 may be configured to receive the captured image data from the imaging device(s) 102 (e.g., via the communicative link 110). The computing system 108 may be configured to process/analyze the received image data to determine one or more values associated with the size and/or shape of the agricultural fluid droplets deposited on the underlying plants. For example, the computing system 108 may be configured to use any suitable image processing techniques to identify the agricultural fluid droplets depicted within the received image data and, subsequently, determine one or more values associated with the sizes and/or shapes of the imaged droplets.

As mentioned above, in several embodiments, the dispensed agricultural fluid may include a dye (e.g., an ultraviolet, infrared, or visible dye). As such, the droplets of the agricultural fluid deposited on the plants may include the dye. The presence of the dye may, in turn, facilitate identification and analysis (e.g., the droplet size/shape determinations). That is, the dye may emit a different light (e.g., an ultraviolet, infrared, or non-green visible light) than the plants, thereby differentiating the agricultural fluid droplets from the plants in the image data captured by the imaging device(s) 102. Thus, the presence of the dye may improve the accuracy of droplet identification and analysis. However, in alternative embodiments, no dye may be present within the agricultural fluid droplets. In such embodiments, the droplets may be identified based on temperature and emissivity differences between the agricultural fluid and the plants depicted within the captured image data.

The computing system 108 may be configured to determine any suitable number of values associated with the sizes and/or shapes of the deposited agricultural fluid droplets. More specifically, numerous droplets of the agricultural fluid are generally deposited on each plant during the spraying operation. As such, in some embodiments, the computing system 108 may be configured to identify and, subsequently, determine size and/or shape values of several droplets present on each plant present within the field(s) of view 104 of the imaging device(s) 102. For example, in one embodiment, the computing system 108 may be configured to further analyze each determined droplet size/shape value (e.g., compare to an associated range) individually. In another embodiment, the computing system 108 may be configured to determine an average or median droplet/size shape value for each imaged plant based on the individual determined size/shape values. Alternatively, the computing system 108 may be configured to identify a single droplet on each imaged plant or a portion of each imaged plant (e.g., each leaf) and subsequently, determine the size and/or shape values of such droplets.

Moreover, the determined sizes and/or shape values of the agricultural fluid droplets may correspond to any parameters associated with the size and/or shape of the droplets. For example, in one embodiment, the determined size values of the droplets may correspond to the maximum diameter or dimension of such droplets. In another embodiment, the determined shape values of the droplets may correspond to the radii of curvature of a portion of such droplets.

In accordance with aspects of the present subject matter, the computing system 108 may be configured to initiate one or more control actions based on the determined size and/or shape values associated with the agricultural fluid droplets depicted in the captured image data. Specifically, in several embodiments, the computing system 108 may be configured to compare the determined size and/or shape values to an associated predetermined range. When the determined size and/or shape values associated with the droplets fall outside of the associated range, the droplets deposited on the plants may be too small or large and/or of an undesirable shape, thereby resulting in poor spray quality and/or an undesirable application rate of the agricultural fluid. For example, the size and/or shape values of the droplets may fall outside of the associated range when the airspeed relative the sprayer 10 is too high (e.g., due to the wind speed and/or the ground speed of the sprayer 10), the pressure of the agricultural fluid is too high or low, and/or the boom assembly 24 is too close to or far away from the canopy of the underlying plants. In such instances, the computing system 108 may be configured to initiate one or more control actions associated with improving the quality issues caused by the airspeed, the agricultural fluid pressure, and/or the boom assembly height.

Moreover, the computing system 108 may be configured to determine when there is a difference in the two or more size and/or shape values associated with the agricultural fluid droplets. More specifically, in certain instances, two or more size and/or shape values associated with the agricultural fluid droplets may differ, such as when one of the nozzles 38 is damaged or partially occluded. In such instances, the droplets dispensed by the damaged/partially occluded nozzle may be of a different size and/or shape than the droplets dispensed by the undamaged/non-occluded nozzles. As such, in several embodiments, the computing system 108 may be configured to compare the two or more determined size and/or shapes values. For example, in one embodiment, the computing system 108 may be configured to determine one or more size and/or shape values associated with the agricultural fluid droplets dispensed by a first nozzle and one or more size and/or shape values associated with the agricultural fluid droplets dispensed by a second nozzle. Thereafter, in such an embodiment, the computing system 108 may be configured to compare the value(s) associated with the first nozzle to the value(s) associated with the second nozzle. When the determined two or more size and/or shape values associated with the agricultural fluid droplets differ by more than a predetermined amount (thereby indicating inconsistencies in the sizes and/or shapes of the deposited droplets), the computing system 108 may be configured to initiate one or more control actions.

Referring still to FIG. 4, as mentioned above, the computing system 108 may be configured to initiate one or more control actions when a determined size and/or shape value associated with the agricultural fluid droplets falls outside of a predetermined range or differs from another value by more than a predetermined amount. In such instances, in one embodiment, the computing system 108 may be configured to notify the operator of sprayer 10. Specifically, in such an embodiment, the computing system 108 may be configured to transmit instructions to the user interface 116 (e.g., via the communicative link 110). The instructions may, in turn, instruct the user interface 116 to provide a visual or audible notification or indicator to the operator. Such notification may indicate that one or more determined values associated with the sizes and/or shapes of the agricultural fluid droplets deposited on the underlying plants have fallen outside of the predetermined range or differ from another determined size/shape value(s) by more than a threshold amount. Thereafter, the operator may then choose to initiate any suitable corrective action he/she believes is necessary, such as manually adjusting the ground speed of the sprayer 10, the pressure of the agricultural fluid supplied to the nozzles 38, and/or the height of the boom assembly 24.

Additionally, in one embodiment, the control action(s) may include adjusting the ground speed of the sprayer 10. Reducing the ground speed of the sprayer 10 may, in turn, improve the sizes and shape of the agricultural fluid droplets deposited on the plants, particularly during windy conditions. For example, in such an embodiment, the computing system 108 may be configured to control the operation of the engine 40, the transmission 42, and/or the braking actuator(s) 44 to execute the desired adjustment to the ground speed of the vehicle 10. Specifically, the computing system 108 may be configured to transmit control signals to such components 40, 42, 44 (e.g., via the communicative link 110). The control signals may, in turn, instruct the components 40, 42, 44 to adjust their operation to decrease the ground speed of the sprayer 10 as desired.

Furthermore, in one embodiment, the control action(s) may include adjusting the pressure of the agricultural fluid supplied to the nozzles 38. Adjusting pressure of the agricultural fluid supplied to the nozzles 38 may, in turn, improve the sizes and shape of the agricultural fluid droplets deposited on the plants. For example, in such an embodiment, the computing system 108 may be configured to control the operation of the pump 52 to execute the desired adjustment to the pressure of the agricultural fluid supplied to the nozzles 38. Specifically, the computing system 108 may be configured to transmit control signals to the pump 52 (e.g., via the communicative link 110). The control signals may, in turn, instruct the pump 52 to adjust its operation to increase or decrease the pressure of the agricultural fluid supplied to the nozzles 38 as desired.

Additionally, in one embodiment, the control action(s) may include adjusting the height of the boom assembly 24 relative to the canopy of the underlying plants. Adjusting height of the boom assembly 24 relative to the canopy of the underlying plants may, in turn, improve the sizes and shape of the agricultural fluid droplets deposited on the plants. For example, in such an embodiment, the computing system 108 may be configured to control the operation of the boom assembly actuator(s) 106 to execute the desired adjustment to the position of the boom assembly 24. Specifically, the computing system 108 may be configured to transmit control signals to the boom assembly actuator(s) 106 (e.g., via the communicative link 110). The control signals may, in turn, instruct the boom assembly actuator(s) 106 to raise or lower the boom assembly 24 relative to the canopy of the underlying plants as desired.

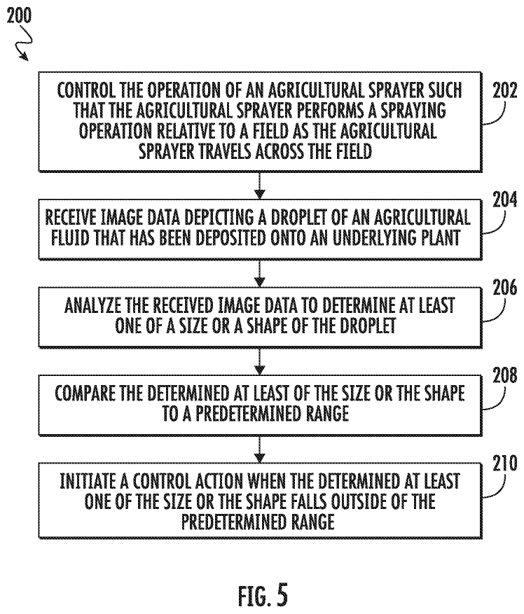

Referring now to FIG. 5, a flow diagram of one embodiment of a method 200 for monitoring an operation of an agricultural sprayer is illustrated in accordance with aspects of the present subject matter. In general, the method 200 will be described herein with reference to the agricultural sprayer 10 and the system 100 described above with reference to FIGS. 1-4. However, it should be appreciated by those of ordinary skill in the art that the disclosed method 200 may generally be implemented with any agricultural sprayers having any suitable sprayer configuration and/or within any system having any suitable system configuration. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 5, at (202), the method 200 may include controlling, with a computing system, the operation of an agricultural sprayer such that the agricultural sprayer performs a spraying operation relative to a field as the agricultural sprayer travels across the field. For instance, as described above, a computing system 108 may be configured to control the operation of one or more components of the agricultural sprayer 10 (e.g., the engine 40, the transmission 42, the braking actuator(s) 44, the pump 52, the metering device 58, and/or the boom assembly actuator(s) 106) such that the sprayer 10 performs a spraying operation relative to a field as the sprayer 10 travels across the field in the direction of travel 18.

Additionally, at (204), the method 200 may include receiving, with the computing system, image data depicting a droplet of an agricultural fluid that has been deposited onto an underlying plant. For instance, as described above, the computing system 108 may be configured to receive image data from one or more imaging devices (e.g., via the communicative link 110) depicting agricultural fluid droplets that have been deposited onto the underlying plants during the spraying operation.

Moreover, as shown in FIG. 5, at (206), the method 200 may include analyzing, with the computing system, the received image data to determine at least one of a size or a shape of the droplet. For instance, as described above, the computing system 108 may be configured to analyze the received image data to determine the size and/or shape values of the agricultural fluid droplets deposited onto the underlying plants during the spraying operation.

Furthermore, at (208), the method 200 may include comparing, with the computing system, the determined at least one of the size or the shape to a predetermined range. For instance, as described above, the computing system 108 may be configured to compare the determined size and/or shape values of the agricultural fluid droplets to an associated predetermined range.

In addition, as shown in FIG. 5, at (210), the method 200 may include initiating, with the computing system, a control action when the determined at least one of the size or the shape falls outside of the predetermined range. For instance, as described above, when the determined size and/or the shape of the agricultural fluid droplets falls outside of the associated predetermined range, the computing system 108 may be configured to initiate one or more control actions. Such control action(s) may include adjusting the height of the boom assembly 24 relative to the canopy of the plants (e.g., by controlling the operation of the boom assembly actuator(s) 106), adjusting the pressure of the agricultural fluid supplied to the nozzles 38 (e.g., by controlling the operation of the pump 52), and/or adjusting the ground speed of the sprayer 10 (e.g., by controlling the operation of the engine 40, the transmission 42, and/or the braking actuator(s) 44).

It is to be understood that the steps of the method 200 are performed by the computing system 108 upon loading and executing software code or instructions which are tangibly stored on a tangible computer readable medium, such as on a magnetic medium, e.g., a computer hard drive, an optical medium, e.g., an optical disc, solid-state memory, e.g., flash memory, or other storage media known in the art. Thus, any of the functionality performed by the computing system 108 described herein, such as the method 200, is implemented in software code or instructions which are tangibly stored on a tangible computer readable medium. The computing system 108 loads the software code or instructions via a direct interface with the computer readable medium or via a wired and/or wireless network. Upon loading and executing such software code or instructions by the computing system 108, the computing system 108 may perform any of the functionality of the computing system 108 described herein, including any steps of the method 200 described herein.

The term “software code” or “code” used herein refers to any instructions or set of instructions that influence the operation of a computer or controller. They may exist in a computer-executable form, such as machine code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. A system for monitoring an operation of an agricultural sprayer, the system comprising:
a boom;
a nozzle mounted on the boom, the nozzle configured to dispense an agricultural fluid onto an underlying plant as the agricultural sprayer travels across a field;
an imaging device configured to capture image data depicting a droplet of the agricultural fluid that has been deposited onto the underlying plant; and
a computing system communicatively coupled to the imaging device, the computing system configured to receive the captured image data from the imaging device, the computing system further configured to analyze the received image data to determine at least one of a size or a shape of the droplet.

2. The system of claim 1, wherein the size of the droplet comprises a maximum dimension of the droplet.

3. The system of claim 1, wherein the computing system is further configured to:
compare the determined at least one of the size or the shape to a predetermined range; and
initiate a control action when the determined at least one of the size or the shape falls outside of the predetermined range.

4. The system of claim 3, wherein the control action comprises adjusting a height of the boom relative to a canopy of the plant.

5. The system of claim 3, wherein the control action comprises adjusting a pressure of the agricultural fluid supplied to the nozzle.

6. The system of claim 3, wherein the control action comprises adjusting a ground speed of the agricultural sprayer.

7. The system of claim 3, wherein the control action comprises providing a notification to an operator of the agricultural sprayer indicating that the determined at least one of the size or the shape of the droplet has fallen outside of the predetermined range.

8. The system of claim 1, wherein the nozzle corresponds to a first nozzle configured to dispense the agricultural fluid onto a first underlying plant as the agricultural sprayer travels across the field, the system further comprising:
a second nozzle mounted on the boom, the second nozzle configured to dispense the agricultural fluid onto a second underlying plant as the agricultural sprayer travels across the field, the captured image data further depicting a droplet of the agricultural fluid that has been deposited onto the second underlying plant, the computing system further configured to:
analyze the received image data to determine at least one of a size or a shape of the second droplet;
compare the determined at least one of the size or the shape of the first droplet and the determined at least one of the size or the shape of the second droplet; and
initiate a control action when the determined at least one of the size or the shape of the first droplet differs from the determined at least one of the size or the shape of the second droplet by a predetermined amount.

9. The system of claim 1, wherein the agricultural fluid comprises a dye.

10. The system of claim 9, further comprising:
a tank configured to store the agricultural fluid;
a conduit configured to convey the agricultural fluid from the tank to the nozzle; and
a metering device configured to dispense the dye into the agricultural fluid.

11. The system of claim 9, wherein the dye comprises an ultraviolet dye and the imaging device comprises an ultraviolet camera.

12. A method for monitoring an operation of an agricultural sprayer, the agricultural sprayer including a boom and a nozzle mounted on the boom, the nozzle configured to dispense an agricultural fluid onto an underlying plant as the agricultural sprayer travels across a field, the method comprising:
controlling, with a computing system, an operation of the agricultural sprayer such that the agricultural sprayer performs a spraying operation relative to the field as the agricultural sprayer travels across the field;
receiving, with the computing system, image data depicting a droplet of the agricultural fluid that has been deposited onto the underlying plant;
analyzing, with the computing system, the received image data to determine at least one of a size or a shape of the droplet;
comparing, with the computing system, the determined at least one of the size or the shape to a predetermined range; and
initiating, with the computing system, a control action when the determined at least one of the size or the shape falls outside of the predetermined range.

13. The method of claim 12, wherein the size of the droplet comprises a maximum dimension of the droplet.

14. The method of claim 12, wherein the control action comprises adjusting a height of the boom relative to a canopy of the plant.

15. The method of claim 12, wherein the control action comprises adjusting a pressure of the agricultural fluid supplied to the nozzle.

16. The method of claim 12, wherein the control action comprises adjusting a ground speed of the agricultural sprayer.

17. The method of claim 12, wherein the control action comprises providing a notification to an operator of the agricultural sprayer indicating that the determined at least one of the size or the shape of the droplet has fallen outside of the predetermined range.

18. The method of claim 12, wherein the nozzle corresponds to a first nozzle configured to dispense the agricultural fluid onto a first underlying plant as the agricultural sprayer travels across the field, the agricultural sprayer further including a second nozzle mounted on the boom, the second nozzle configured to dispense the agricultural fluid onto a second underlying plant as the agricultural sprayer travels across the field, the received image data further depicting a droplet of the agricultural fluid that has been deposited onto the second underlying plant, the method further comprising:
analyzing, with the computing system, the received image data to determine at least one of a size or a shape of the second droplet;
comparing, with the computing system, the determined at least one of the size or the shape of the first droplet and the determined at least one of the size or the shape of the second droplet; and
initiating, with the computing system, a control action when the determined at least one of the size or the shape of the first droplet differs from the determined at least one of the size or the shape of the second droplet by a predetermined amount.

19. The method of claim 12, wherein the agricultural fluid comprises a dye.

20. The method of claim 19, wherein the dye comprises an ultraviolet dye.
